(19) United States
(12) Patent Application Publication
(10) Pub. No.: US 2010/0314364 A1
(43) Pub. Date: Dec. 16, 2010

(54) OPTICAL SCANNER AND ITS APPLICATIONS

(75) Inventor: Reijo Lappalainen, Hiltulanlahti (FI)

Correspondence Address: YOUNG & THOMPSON, 209 Madison Street, Suite 500, Alexandria, VA, 22314, US

(73) Assignee: PICODEON LTD OY, HELSINKI (FI)

(21) Appl. No.: 12/521,712

(22) PCT Filed: Dec. 31, 2007
(86) PCT No.: PCT/FI07/50724

§ 371 Date: Jun. 29, 2009

(30) Foreign Application Priority Data
Dec. 29, 2006 (FI) 20065867

(51) Int. Cl. B23K 26/02; G02B 26/12

(52) U.S. Cl. 219/121.67; 359/216.1

(57) ABSTRACT

The present invention relates generally to optical scanners. The invention has advantageous applications e.g. in the field laser technology, such as coating and machining with cold ablation technology. An optical scanner according to the invention has a rotating mirror (210), and the reflecting surface (214) of the mirror has an angle in relation to the axis of rotation (216), which varies as a function of the position in the mirror. This way it is possible to provide an optical scanner without discontinuation points and an accurate scanning speed throughout the scanning area.

### FIELD OF INVENTION

The present invention relates generally to optical scanners. More specifically, the present invention relates to what is disclosed in the preamble of the independent claim. The invention has advantageous applications e.g. in the field laser technology, such as coating and machining with cold ablation technology.

### BACKGROUND

In the recent years, considerable development of the laser technology has provided means to produce very high-efficiency laser systems that are based on semi-conductor fibres, thus supporting advance in so called cold ablation methods. Cold ablation is based on forming high energy laser pulses of short duration, such as within picosecond range, and directing the pulses into the surface of a target material. A plume of plasma is thus ablated from the area where the laser beam hits the target. The applications of cold ablation include e.g. coating and machining. In such applications it is necessary to control the position of the laser beam in order to hit the correct location in the target. The laser beam is usually scanned at the surface of the target material in order to treat a predetermined area of the target surface. It is common to use optical scanners for this purpose.

The prior art laser treatment systems most often include optical scanners which are based on vibrating mirrors. Such an optical scanner is disclosed in e.g. document DE10343080. A vibrating mirror oscillates between two determined angles relative to an axis which is parallel to the mirror. When a laser beam is directed to the mirror, it is reflected with an angle which depends on the position of the mirror at that moment. The vibrating mirror thus reflects or “scans” the laser beam into points of a line at the surface of a target material.

However, there are some problems related to the prior art optical scanners, especially when used in laser cold ablation applications. A vibrating mirror changes its direction of angular movement at its end positions, and due to moment of inertia, the angular velocity of the mirror is not constant near to its end positions. This causes irregular treatment of the target material at the edges of the scanned area.

In industrial applications it is important to achieve high efficiency of laser treatment. In cold ablation, the intensity of the laser pulses must exceed a predetermined threshold value in order to facilitate the cold ablation phenomenon. This threshold value depends on the target material. In order to achieve high treatment efficiency, the repetition rate of the pulses should be high, such as several MHz. On the other hand, it is advantageous not to direct several successive laser pulses into the same location of the target surface because this would cause a cumulating effect in the target material. This would lead to heating of the target material and release of particles from the target material, instead of plasma. Thus the advantages of the cold ablation would be lost. Therefore, to achieve a high efficiency of the treatment, it is also necessary have a high scanning speed of the laser beam. The velocity of the beam at the surface of the target should generally be more than 10 m/s to achieve efficient processing, and preferably more than 50 m/s and more preferably more than 100 m/s. However, in optical scanners based on a vibrating mirror the moment of inertia prevents achieving sufficiently high angular velocity of the mirror. The obtained velocity of the laser beam at the target surface is therefore just a few m/s.

A vibrating mirror of an optical scanner receives the laser beam into a small, constant area at the mirror during the whole oscillation cycle of the mirror. The laser beam is partially absorbed at the mirror, and when high laser energies are used, the partial absorption of the laser beam heats the mirror substantially. As the heat is absorbed within a small area of the mirror, it is difficult to remove the heat in a sufficiently efficient manner, and the mirror may therefore get overheated and damaged.

Document U.S. Pat. No. 6,063,455 discloses a scanner arrangement where mirrors are moved linearly back and forth in a direction of the surface of a target. However, this arrangement has the same disadvantages as the scanner with vibrating mirrors, and the obtained scanning speed is even lower.

It is also known to use rotating, polygonal mirrors as optical scanners in some laser applications. Such an optical scanner is disclosed in e.g. document JP7035996. It would be possible to achieve a higher scanning speed with polygonal scanners, but there are also be some problems related to using such scanners in high power cold ablation applications. A polygonal scanner has at least three edges, each of which forms a discontinuation area for the laser beam. This causes the laser beam to be instantaneously reflected to possibly unwanted and harmful areas within or outside the instrument.

### SUMMARY OF THE INVENTION

An object of the present invention is to provide an optical scanner for various applications, wherein the described disadvantages of the prior art are avoided or reduced. The object of the invention is therefore to achieve an optical scanner which allows high scanning speeds, a controllable beam deflection and/or ability to treat high power laser beams.

The object of the invention is achieved by providing an optical scanner which has a rotating mirror, and the reflecting surface of the mirror has an angle in relation to the axis of rotation, which angle varies as a function of the position at the mirror.

More specifically, the object of the invention is achieved by providing an optical scanner, comprising at least one mirror for reflecting a received light beam, wherein the direction of a reflected light beam is controlled by moving the at least one mirror,

which optical scanner is characterized in that
the optical scanner comprises means for moving the mirror along a rotational path wherein the rotational path has a main axis of rotation,
an angle between the mirror surface and the axis of rotation varies as a function of position along the mirror surface,
based on said varying angle of the mirror, the mirror of the optical scanner is arranged to deflect a light beam in a reflection angle which is dependent on the position of the mirror in its rotational path.

The invention further relates to a system for treatment of material using laser ablation, which is characterized in that it comprises
an arrangement according to the invention for treating material, and
automated means arranged to handle the ablation target bodies for their input, movement and/or removal from the system.

According to one embodiment of the invention varying of said angle between the mirror surface and the axis of rotation causes the reflected light beam to form a path of a line at its target. This path of a line may for example have a direction of the axis of rotation, or a direction which is close to the direction of the axis of rotation. The directions of the line and the axis of rotation may thus be parallel of close to parallel, for example.

According to one embodiment of the invention the mirror has a shape of a cylinder, and the cylinder is oblique in relation to the axis of rotation. According to another embodiment of the invention the optical scanner comprises means for balancing the weight of the mirror when in rotation.

According to a further embodiment of the invention the mirror has no edges or discontinuation points in its surface along a cross section which is perpendicular with the axis of rotation of the mirror. According to another embodiment of the invention the mirror has one edge and/or discontinuation point in its surface along a cross section which is perpendicular with the axis of rotation of the mirror. According to a further embodiment of the invention the mirror has at least two edges and/or discontinuation points in its surface along a cross section which is perpendicular with the axis of rotation of the mirror.

According to one further embodiment of the invention the optical scanner is a unidirectional scanner. According to an alternative embodiment of the invention the optical scanner is a bidirectional scanner.

According to one embodiment the inventive arrangement is arranged to cold work the ablation target. According to an alternative embodiment the arrangement is arranged to coat a substrate with a plasma plume received from the ablation target.

According to one embodiment of the invention the system comprises automated means arranged to feed ablation target material for maintaining an ablation plume, from the ablation target, for coating of a substrate. According to a further embodiment the system comprises means to set and/or hold a substrate into contact with the plume of the ablation material as ablated from the ablation target. There may also be automated means for feeding the substrate bodies and removing the coated/machined substrate bodies.

Some further embodiments are described in dependent claims.

The present invention has substantial advantages over prior art solutions. It is possible to provide an optical scanner with no discontinuation edges in the mirror. This way it is possible to have a continuous control over the direction of the reflected laser beam. If needed, it is also possible to provide one, two or several discontinuation edges.

With the present invention it is also possible to provide a constant scanning velocity throughout the treated target area. It is also possible to provide a scanning speed which varies as a function of the scanned target location. Thus it is, for example, possible to compensate any irregularities in the scanning procedure or optical paths. Such a varying scanning speed is possible by providing a suitable geometry of the rotating mirror. It is also possible to provide various geometries of the scanning path at the target by designing the mirror accordingly. The path may be a direct line, curved line or other determined geometry. A line shaped path at a target is typically a succession of laser pulses which appear as dots forming a line at the target surface.

It is possible to obtain high scanning speeds with the optical scanner according to the invention. If good weight balancing is provided, high rotational velocities are achieved. The scanning speed may easily be more than 100 m/s.

It is possible to provide either a unidirectional scanner or a bidirectional scanner according to the invention. It is also possible to have a changeable mirror in the optical scanner so that the scanning type or scanning geometry can be selected according to the related application.

Since the mirror of the optical scanner according to the invention is rotating, a laser beam hits a large area on the mirror, and therefore the heat caused by partial absorption of the laser beam is also spread into a large area. It is also possible to increase the area by increasing the diameter of the mirror/rotational path. Further, since it is possible to design the mirror hollow in the middle, it is easy to arrange air cooling for the mirror. It is also possible to arrange cooling with flowing liquid. The cooling liquid can be led to the inner surface by providing a hollow tube as a shaft rotating the mirror. The cooling liquid can thus be led through the rotating tube and be made to circulate via the inner surface of the mirror.

The optical scanner according to the invention is especially suitable for laser ablation coating where uniform, homogeneous surfaces are required, and/or where large areas are treated. The optical scanner is also especially suitable for high quality and/or efficient machining where the trace of the laser treatment is accurately controlled.

In this patent application term “light” means any electromagnetic radiation which can be reflected and “laser” means light which is coherent or a light source producing such light. “Light or “laser” is thus not restricted in any way to the visible part of the light spectrum.

In this patent application term “unidirectional” optical scanner means that the reflected light beam performs scanning in substantially single direction when the mirror of the scanner rotates in a constant direction.

In this patent application term “bidirectional” optical scanner means that the reflected light beam performs scanning in substantially two opposite directions sequentially when the mirror of the scanner rotates in a constant direction.

In this patent application term “inner surface” of a rotating mirror means the surface which is facing towards the axis of rotation. An “outer surface” of a rotating mirror means the surface which is at the opposite side from the inner surface of the mirror.

In this patent application term “active surface” of a mirror in an optical scanner means the surface which is specifically provided for scanning a light beam.

In this patent application term “angle between mirror surface and axis of rotation” at a certain point of the mirror means an angle which is formed between the axis of rotation and a tangential plane which is imagined at the determined point of the mirror. The value of the angle may also be zero degrees when the tangential plane is parallel with the axis of rotation.

In this patent application term “coating” means forming material of any thickness on a substrate. Coating thus may also mean producing thin films with a thickness of e.g. <1 μm.

### BRIEF DESCRIPTION OF THE DRAWINGS

The described and other advantages of the invention will become apparent from the following detailed description and by referring to the drawings where:

FIG. 1a illustrates an exemplary bidirectional optical scanner according to the invention,

FIG. 1b illustrates the exemplary optical scanner of FIG. 1a after the mirror is rotated by 90 degrees,

FIG. 2a illustrates reflection of a light beam in an exemplary optical scanner according to the invention, when the mirror is at 0 degree position,

FIG. 2b illustrates reflection of a light beam in the exemplary optical scanner of FIG. 2a, when the mirror is at 90 degrees position,

FIG. 2c illustrates reflection of a light beam in the exemplary optical scanner of FIG. 2a, when the mirror is at 180 degrees position,

FIG. 2d illustrates reflection of a light beam in the exemplary optical scanner of FIG. 2a, when the mirror is at 270 degrees position,

FIG. 3a illustrates an end view of an exemplary optical scanner according to the invention, comprising compensating weights,

FIG. 3b illustrates a view from another end of the exemplary optical scanner of FIG. 3a,

FIG. 4a illustrates reflection of a light beam in a further exemplary unidirectional optical scanner according to the invention, when the mirror is at 0 degree position,

FIG. 4b illustrates reflection of a light beam in the exemplary optical scanner of FIG. 4a, when the mirror is at 90 degrees position,

FIG. 4c illustrates reflection of a light beam in the exemplary optical scanner of FIG. 4a, when the mirror is at 180 degrees position,

FIG. 4d illustrates reflection of a light beam in the exemplary optical scanner of FIG. 4a, when the mirror is at 270 degrees position,

FIG. 4e illustrates reflection of a light beam in the exemplary optical scanner of FIG. 4a, when the mirror is at 360 degrees position and where light beam has not crossed the edge,

FIG. 5 illustrates an arrangement for treating material using laser ablation in a coating application,

FIG. 6a illustrates an exemplary trace of the scanned laser beam at the surface of the target when using a bidirectional optical scanner, and

FIG. 6b illustrates an exemplary trace of the scanned laser beam at the surface of the target when using a unidirectional optical scanner.

### DETAILED DESCRIPTION

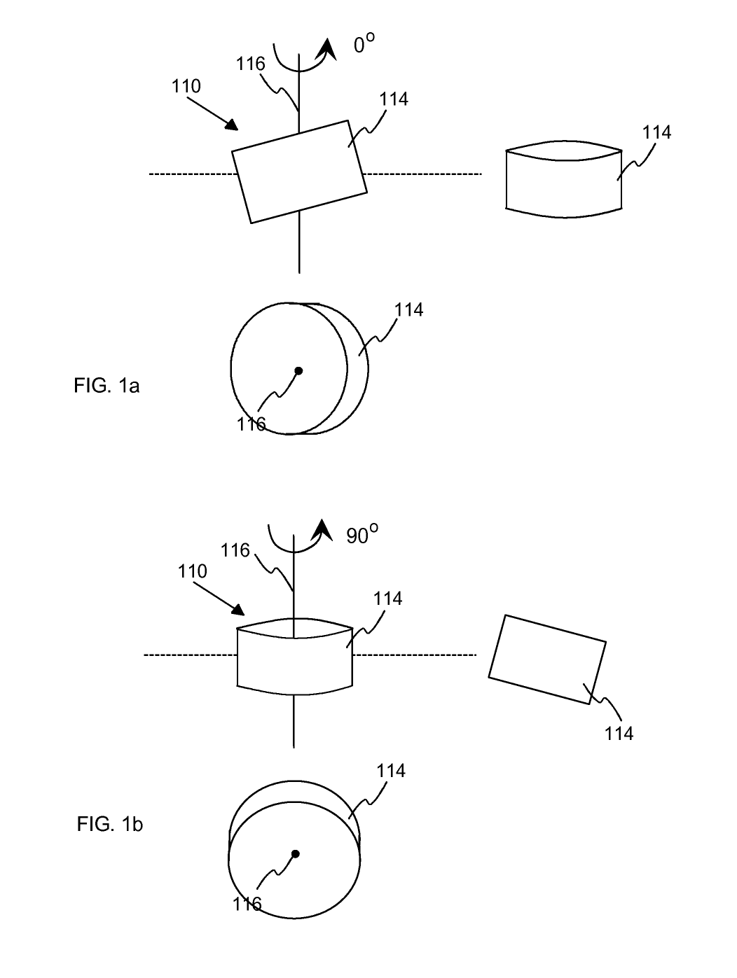

FIGS. 1a and 1b show a rotating mirror 110 of an exemplary optical scanner according to the invention. The mirror is arranged to rotate around the axis of rotation 116. FIG. 1b shows the mirror turned by 90 degrees compared to the FIG. 1a. FIGS. 1a and 1b also show the side view and the end view of the mirror. The mirror has a shape of a cylinder, which is slightly tilted in relation to the axis of rotation 116. The mirror is shown as a tilted cylinder in order to better visualize the form of the mirror, and the ends of the mirror are therefore oblique. However, it would also be possible to have edges which are perpendicular to the axis of rotation. The optical scanner has an axle at the axis of rotation, in which the mirror is connected. The mirror may be connected to the rotating axle with e.g. end plates or spokes (not shown in the Figure).

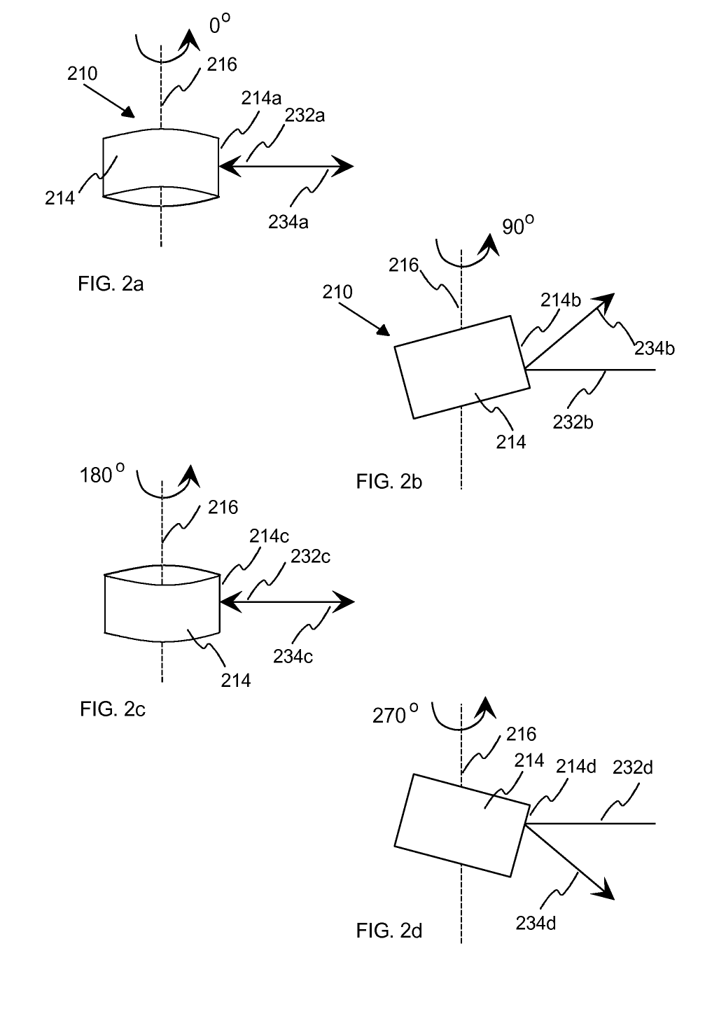

FIGS. 2a, 2b, 2c and 2d illustrate the deflection of a reflected laser beam of an optical scanner which is similar to the scanner shown in FIGS. 1a and 1b. FIG. 2a shows the mirror 210 in a basic position, FIG. 2b shows the mirror rotated by 90 degrees, FIG. 2c shows the mirror rotated by 180 degrees, and FIG. 2d shows the mirror rotated by 270 degrees from the position of FIG. 2a. The Figures show the mirror from a perpendicular view in relation to the axis of rotation.

In FIG. 2a the active, reflecting mirror surface 214 has a direction of the axis of rotation at the point 214a where the laser beam is reflected. If the laser beam 232a arrives with a direction perpendicular to the axis of rotation, the reflected beam 234a will have the same but opposite direction as the arriving beam 232a.

In FIG. 2b the mirror surface at the point 214b where the arriving laser beam 232b hits the mirror is tilted to its maximum angle in relation to the axis of rotation. Thus also the angle of the reflected beam 234b is in its maximum.

In FIG. 2c the mirror surface 214 has again a direction of the axis of rotation at the point 214c where the laser beam is reflected. The reflected beam 234c will have the same but opposite direction as the arriving beam 232c.

In FIG. 2d the mirror surface at the point 214d where the arriving laser beam 232d hits the mirror is tilted to its maximum angle in relation to the axis of rotation. However, the angle is now opposite compared to FIG. 2a. Thus also the angle of the reflected beam 234d is in its other maximum.

The FIGS. 2a-2d show how the rotating mirror 210 reflects the laser beam in varying angles. This optical scanner is bidirectional, i.e. reflection angle changes back and forth when the mirror rotates in a constant direction.

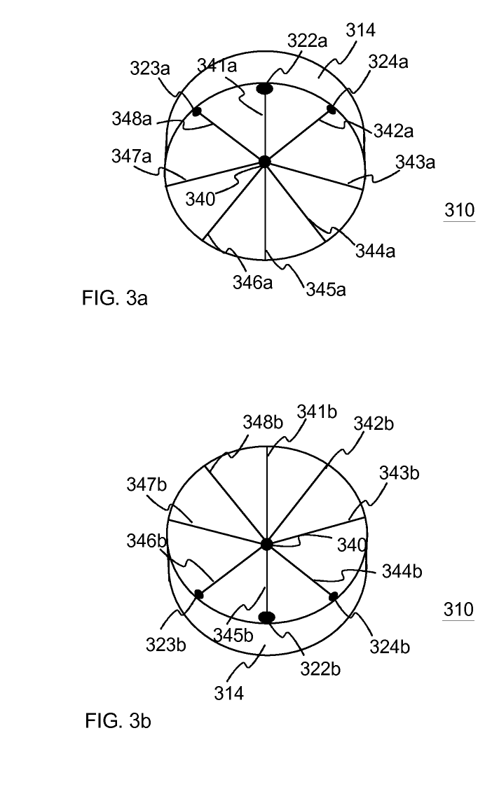

FIGS. 3a and 3b show the attachment of the mirror to the rotating axle. FIGS. 3a and 3b show the end views of the mirror 310 from the opposite ends. There are eight attachment spokes 341a-348a at the first end of the mirror, and eight attachment spokes 341b-348b at the second end of the mirror. The cylindrical mirror has an asymmetric position in relation to the axis of rotation, and therefore balancing weights are used for balancing the mirror during its rotation. The largest balancing weights 322a and 322b are located at ends of the shortest spokes 341a and 345b. Smaller weights 323a, 323b, 324a and 324b are located at ends of spokes which are next to the shortest spokes. The values of the balancing weights can be calculated on the basis of centrifugal forces at the used speed of rotation. The mirror itself can naturally be designed using such material thicknesses that the mirror is balanced without additional balancing weights.

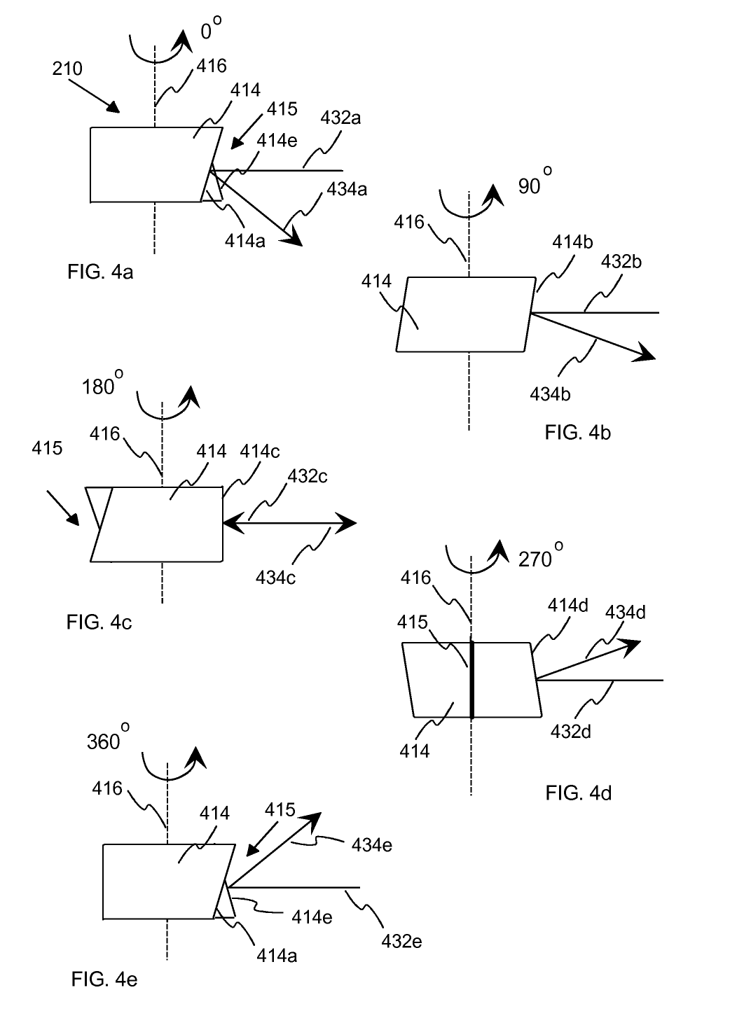

FIGS. 4a, 4b, 4c, 4d and 4e illustrate a second exemplary embodiment of the optical scanner according to the invention. This optical scanner is unidirectional, i.e. the reflected beam scans in one direction when the mirror rotates in a constant direction. The reflected beam thus returns to its starting point without an actual scanning function. FIG. 4a shows the mirror 410 in a basic position, FIG. 4b shows the mirror rotated by 90 degrees, FIG. 4c shows the mirror rotated by 180 degrees, FIG. 4d shows the mirror rotated by 270 degrees, and FIG. 4e shows the mirror rotated by 360 degrees from the position of FIG. 4a.

FIG. 4a shows a discontinuation edge 415. The mirror is at such a position that the arriving laser beam 432a is reflected from a tilted surface of the mirror at point 414a. The reflection angle is at its first maximum. After a rotation of 90 degrees in FIG. 4b the reflection angle has reduced to half compared to the basic position. Further, in FIG. 4c the mirror surface has the direction of the rotating axis in a location 414c where the beam is reflected. The laser beam is thus reflected, 434c, into the opposite direction to the arriving beam 432c. In FIG. 4d the mirror surface is slightly tilted at the opposite direction compared to FIG. 4b. Finally, in FIG. 4e the mirror surface is tilted into a second maximum at the location 414e where the laser beam is reflected. This location is just before the discontinuation edge 415. When the beam has passed the discontinuation edge, the mirror begins again to scan from the position of FIG. 4a.

The embodiment of FIGS. 4a-4e shows a mirror with just one discontinuation edge. However, it is alternatively possible to provide two or several discontinuation edges. This way it will be possible to scan two or several lines during the rotation of one revolution, and the scanning rate can thus be increased. One should note that it is also possible to provide discontinuation edges in bidirectional optical scanners according to the invention. This way it will be possible to scan two or several back-and-forth lines during the rotation of one revolution, and the scanning rate can thus be increased also in a bidirectional optical scanner.

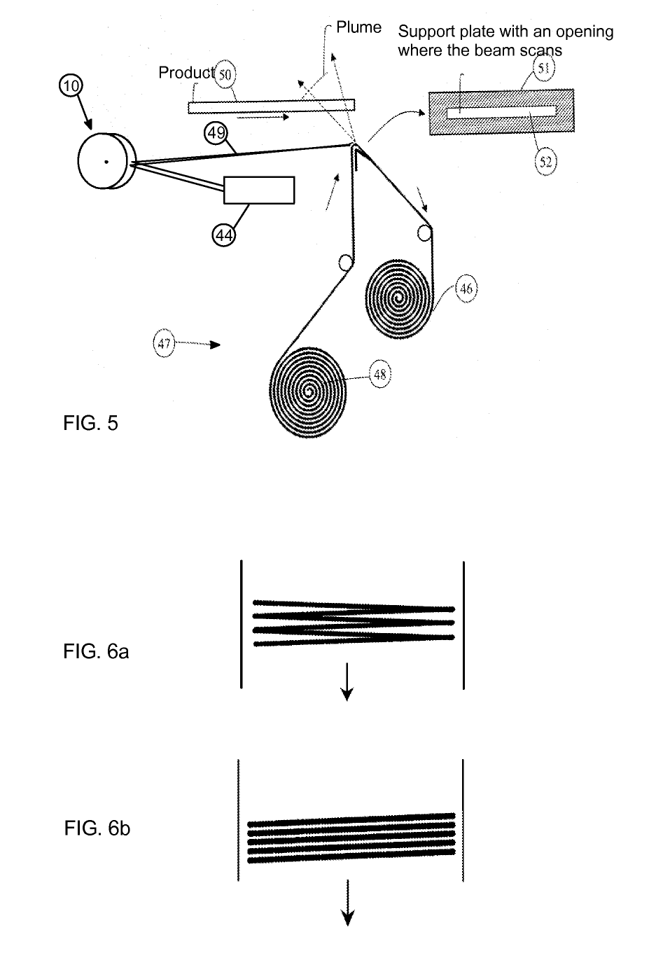

FIG. 5 illustrates an exemplary system for treating material with laser ablation. A laser beam formed by a laser source 44 and scanned with an optical scanner 10 towards the target. The target 47 has a form of a band which is spooled from a feed roll 48 into a discharge roll 46. The target is supported with a support plate 51 which has an opening 52 at the location of ablation. When the laser beam 49 received from the scanner hits the target, material is ablated, and a plasma plume is provided. In a coating application a product 50 to be coated is provided into the plasma plume. The product will thus be coated with the target material. In a machining or “cold-work” application, the target material is treated generally without exploiting the ablated plasma for coating. In machining applications the target is generally a product which is cut or otherwise machined with laser ablation.

The optical scanner according to the invention generally has a convex or a concave reflecting surface. Thus it is possible to use the mirror also for expanding or focusing a light beam. It may, however be necessary to have corrective optics, such as lenses within the optical path of the light beam, preferably between the laser source and the optical scanner.

In this patent specification the structure of the other various components of a laser ablation apparatus is not described in more detail as they can be implemented using the description above and the general knowledge of a person skilled in the art.

FIGS. 6a and 6b illustrate exemplary traces of scanned laser beams at a surface of a target material which moves in the direction of the arrow. FIG. 6a illustrates a trace when bidirectional optical scanner is used. FIG. 6b illustrates a trace when unidirectional optical scanner is used. In these Figures there are gaps between adjacent traces, but it is naturally possible to make the adjacent traces overlapping by increasing the scanning rate or by slowing the movement of the target material.

Above, only some embodiments of the solution according to the invention have been described. The principle according to the invention can naturally be modified within the frame of the scope defined by the claims, for example, by modification of the details of the implementation and ranges of use.

For example, although the invention is described with embodiments where the optical scanner has one uniform mirror, it is also possible to provide the required reflection pattern by using several separate mirrors.

Also, even if the described embodiments have shown a circular path of rotation, it is also possible to use other kind of rotational paths.

Further, the described embodiments have shown mirror which has a form of a cylinder, which is oblique in relation to the rotating axis. However, various other forms are naturally possible, such as an oblique cone.

The described embodiments have included a mirror which has its active, reflecting surface at its outer surface, which is generally convex shaped. However, it is also possible to use the inner surface of the mirror as the active reflecting surface, which is generally concave. In this case, a laser beam is preferably arranged to arrive to the mirror through one end of a rotating mirror and to direct the reflected beam through another end of the rotating mirror. In such an optical scanner it may be necessary to support and rotate the mirror from the outside instead of using a rotating shaft at the axis of rotation.

Coating and cold-work based on laser ablation have been mentioned as exemplary applications for the optical scanner. However, it is also possible to use laser ablation for other purposes such as producing new materials based on the plasma of the target material. Also, there are numerous applications other than laser ablation where optical scanners according to the invention can be used. Such applications may include e.g. laser printers, laser copiers and bar code readers.

1. Optical scanner, comprising at least one mirror (210) for reflecting a received light beam, wherein the direction of a reflected light beam is controlled by moving the at least one mirror,
characterized in that
the optical scanner comprises means (340, 341a-348a, 341b-348b) for moving the mirror along a rotational path wherein the rotational path has a main axis of rotation (216),
an angle between the mirror surface (214, 214a-214d) and the axis of rotation (216) varies as a function of position along the mirror surface,
based on said varying angle of the mirror, the mirror of the optical scanner is arranged to deflect a light beam (234a-234d) in a reflection angle which is dependent on the position of the mirror in its rotational path.

2. An optical scanner according to claim 1, characterized in that the varying of said angle between the mirror surface and the axis of rotation causes the reflected light beam to form a path of a line at its target.

3. An optical scanner according to claim 2, characterized in that the direction of the line is same as or close to the direction of the axis of rotation of the mirror.

4. An optical scanner according to claim 1, characterized in that the mirror has a shape of a cylinder, and the cylinder is oblique in relation to the axis of rotation.

5. An optical scanner according to claim 1, characterized in that it comprises means (322a-324a, 322b-324b) for balancing its weight when in rotation.

6. An optical scanner according to claim 1, characterized in that the mirror has no edges or discontinuation points in its surface along a cross section which is perpendicular with the axis of rotation of the mirror.

7. An optical scanner according to claim 1, characterized in that the mirror has one edge and/or discontinuation point (415) in its surface along a cross section which is perpendicular with the axis of rotation of the mirror.

8. An optical scanner according to claim 1, characterized in that the mirror has at least two edges and/or discontinuation points in its surface along a cross section which is perpendicular with the axis of rotation of the mirror.

9. An optical scanner according to claim 1, characterized in that it comprises means for cooling the mirror.

10. An optical scanner according to claim 1, characterized in that an outer surface of a rotating mirror serves as for reflecting the light beam.

11. An optical scanner according to claim 1, characterized in that an inner surface of a rotating mirror serves for reflecting the light beam.

12. An optical scanner according to claim 1, characterized in that it is a unidirectional scanner (410).

13. An optical scanner according to claim 1, characterized in that it is a bidirectional scanner (210).

14. An arrangement for treatment of material, characterized in that it comprises
a laser radiation source (44) to provide the laser radiation for ablation,
at least one optical scanner (10) according to claim 1, located at the optical path (49) of the laser radiation and arranged to lead laser radiation from said laser radiation source to the hit spot of an ablation target (47).

15. An arrangement according to claim 14, characterized in that the arrangement is arranged to cold-work the ablation target.

16. An arrangement according to claim 14, characterized in that the arrangement is arranged to coat a substrate with a plasma plume received from the ablation target.

17. A system for treatment of material using laser ablation, characterized in that it comprises
an arrangement according to claim 14 for treating material, and
automated means arranged to handle the ablation target bodies and/or substrate products for their input, movement and/or removal from the system.

18. A system according to claim 17, characterized in that the system comprises automated means arranged to feed ablation target material for maintaining an ablation plume, from the ablation target, for coating of a substrate (50).

19. A system according to claim 17, characterized in that system comprises means to set and/or hold a substrate into contact with the plume of the ablation material as ablated from the ablation target.

20. A system according to claim 18, characterized in that system comprises means to set and/or hold a substrate into contact with the plume of the ablation material as ablated from the ablation target.
